(19) United States
(12) Patent Application Publication
(10) Pub. No.: US 2026/0105846 A1
(43) Pub. Date: Apr. 16, 2026

(54) DETERMINING BERTHING FEASIBILITY FOR A MARINE VESSEL

(71) Applicant: CPAC SYSTEMS AB, Göteborg (SE)

(72) Inventors: Axel MÅNESKIÖLD, Göteborg (SE); Valter STRÖMBERG, Mölndal (SE)

(73) Assignee: CPAC SYSTEMS AB, Göteborg (SE)

(21) Appl. No.: 19/350,830

(22) Filed: Oct. 6, 2025

(30) Foreign Application Priority Data
Oct. 11, 2024 (EP) 24206156.2

(51) Int. Cl. G08G 3/00; B63B 79/20

(52) U.S. Cl. CPC G08G 3/00; B63B 79/20; B63B 2213/00

(57) ABSTRACT

A computer system has processing circuitry to obtain localization data of berthing areas in connection with nature landmasses; identify potential berthing location(s) where the marine vessel can attempt to berth within the berthing areas; obtain wind forecast data for an upcoming berthing time period expected for the marine vessel at said at least one potential berthing location; based on the wind forecast data, determine a wind influence value for the marine vessel during said estimated upcoming berthing time period at said at least one potential berthing location, wherein a relatively higher wind influence value indicates a lesser berthing feasibility and a relatively lower wind influence indicates a greater berthing feasibility; and determine the berthing feasibility for the marine vessel based on its respective wind influence value at said at least one potential berthing location.

### TECHNICAL FIELD

The disclosure relates generally to marine vessel berthing. In particular aspects, the disclosure relates to determining berthing feasibility for a marine vessel. The disclosure can be applied to marine vessels, such as leisure boats, ships, cruise ships, fishing vessels, yachts, ferries, among other vehicle types. Although the disclosure may be described with respect to a particular marine vessel, the disclosure is not restricted to any particular marine vessel.

### BACKGROUND

Berthing a marine vessel at sea, especially in unpredictable and unstructured environments such as natural landmasses without built harbors or docks, presents numerous difficulties, including unpredictable sea conditions, lack of protective structures, and changing environmental factors. Traditional berthing methods often rely on real-time observations and historical data to determine safe and feasible berthing spots, yet these methods are inherently limited for example due to the dynamic nature of the sea and other environmental conditions. Present solutions are therefore typically manual by the crew and oftentimes based on historic personal knowledge of how berthing is usually carried out at a certain area. This has obvious drawbacks due to the dynamicity of environmental conditions and is impossible for operators without former knowledge of a certain area.

The present inventors have therefore identified a need for an improved approach with regards to the above-identified deficiencies of the prior art and others.

### SUMMARY

One of the primary issues with prior art solutions is their reliance on static or near real-time data, which do not account for the dynamic and often volatile nature of sea conditions. This limitation is particularly pronounced in natural docking scenarios where there are no constructed barriers or predefined berthing areas. In such cases, the sea conditions can change rapidly, with factors such as wind, tide, and current having substantial and often unpredictable impacts on the safety and feasibility of a berthing location. For instance, prior art methods might use satellite imagery or sonar data to identify potential berthing spots, but these technologies do not provide insights into how these spots might be influenced by future environmental changes. Additionally, traditional approaches might involve manual scouting and real-time decision-making by the crew, which can be highly subjective and prone to errors due to the lack of predictive information.

Consequently, the unpredictability of sea conditions means that a spot deemed safe at one moment can quickly become hazardous, leading to increased risks for the vessel and its crew. This unpredictability is exacerbated in nature dock scenarios where the absence of protective structures leaves vessels more exposed to environmental forces.

In a first aspect of the disclosure there is provided a computer system for determining a berthing feasibility for a marine vessel, the computer system comprising processing circuitry configured to: obtain localization data of one or more berthing areas in connection with one or more nature landmasses; based on the localization data, identify at least one potential berthing location where the marine vessel can attempt to berth within the berthing areas; obtain wind forecast data for an upcoming berthing time period expected for the marine vessel at said at least one potential berthing location; based on the wind forecast data, determine a wind influence value for the marine vessel during said estimated upcoming berthing time period at said at least one potential berthing location, wherein a relatively higher wind influence value indicates a lesser berthing feasibility and a relatively lower wind influence indicates a greater berthing feasibility; and determine the berthing feasibility for the marine vessel based on its respective wind influence value at said at least one potential berthing location.

The first aspect of the disclosure may seek to address the challenge of accurately determining safe and feasible berthing locations. A technical benefit may include enhanced decision-making for berthing operations by utilizing predictive wind data, offering improved safety and operational efficiency.

Optionally in some examples, including in at least one preferred example, the processing circuitry is configured to determine the wind influence value by: obtaining the wind forecast data as a plurality of wind vectors, each wind vector comprising a direction and a magnitude of wind influence on the marine vessel for a predetermined time sequence during the estimated upcoming berthing time period; and analyzing the stored wind vectors. A technical benefit may include enhanced accuracy by considering both the direction and magnitude of wind conditions over time.

Optionally in some examples, including in at least one preferred example, the processing circuitry is configured to analyze the stored wind vectors by: increasing the wind influence value where the direction of the wind influence points towards the nature landmasses; and decreasing the wind influence value where the direction of the wind influence points away from the nature landmasses. A technical benefit may include improved assessment of sheltered versus exposed berthing spots by adjusting influence based on wind direction.

Optionally in some examples, including in at least one preferred example, the processing circuitry is configured to analyze the stored wind vectors by: increasing the wind influence value where the magnitude of the wind influence is greater than a first wind tolerance value; and decreasing the wind influence value where the magnitude of the wind influence is lesser than the first wind tolerance value. A technical benefit may include providing an accumulative approach of establishing berthing decisions by evaluating wind magnitude against a tolerance.

Optionally in some examples, including in at least one preferred example, the processing circuitry is configured to analyze the stored wind vectors by: comparing magnitudes of the wind influence for the marine vessel with respect to different potential berthing locations, and performing a relative weighing of the wind influence value among said different potential berthing locations based on said comparison. A technical benefit may include improved selection based on relative conditions by comparing wind influences across locations.

Optionally in some examples, including in at least one preferred example, the processing circuitry is configured to analyze the stored wind vectors by: omitting potential berthing locations where the direction of the wind influence points towards the nature landmasses and the magnitude of the wind influence is greater than a second wind tolerance value. A technical benefit may include enhanced safety by excluding high-risk berthing spots.

Optionally in some examples, including in at least one preferred example, the processing circuitry is further configured to: obtain seabed topography data for each potential berthing location; and determine the berthing feasibility for the marine vessel based on the seabed topography data and vessel properties of the marine vessel. A technical benefit may include ensuring that the vessel's specifications align with underwater conditions for safe berthing by integrating seabed data.

Optionally in some examples, including in at least one preferred example, the processing circuitry is further configured to: obtain landmass topography data for the one or more nature landmasses; and determine the berthing feasibility for the marine vessel based on the landmass topography data. A technical benefit may include providing additional context for evaluating natural wind barriers by considering landmass topography.

Optionally in some examples, including in at least one preferred example, the processing circuitry is further configured to generate a berthing map being a virtual representation of said one or more berthing areas and said one or more nature landmasses, the berthing map involving one or more graphical indications of the berthing feasibility for the marine vessel, the graphical indications of the berthing map being highlighted according to an order of the berthing feasibility. A technical benefit may include aiding in quick decision-making by graphically displaying feasibility through a visual berthing map.

Optionally in some examples, including in at least one preferred example, the processing circuitry is further configured to communicate the berthing feasibility, and optionally vessel properties, of the marine vessel to one or more of an external vessel system and a remote server. A technical benefit may include improved coordination with external systems and enhanced overall maritime safety by sharing feasibility data, effectively allowing other vessels to retrieve relevant berthing feasibility information for their respective operations.

In a second aspect of the disclosure there is provided a marine vessel comprising the computer system of the first aspect.

The second aspect of the disclosure may seek to address the challenge of accurately determining safe and feasible berthing locations. A technical benefit may include enhanced decision-making for berthing operations by utilizing predictive wind data, offering improved safety and operational efficiency.

In a third aspect of the disclosure there is provided a computer-implemented method for determining a berthing feasibility for a marine vessel, comprising obtaining, by processing circuitry of a computer system, localization data of one or more berthing areas in connection with one or more nature landmasses; based on the localization data, identifying, by the processing circuitry, at least one potential berthing location where the marine vessel can attempt to berth within the berthing areas; obtaining, by the processing circuitry, wind forecast data for an upcoming berthing time period expected for the marine vessel at said at least one potential berthing location; based on the wind forecast data, determining, by the processing circuitry, a wind influence value for the marine vessel during said estimated upcoming berthing time period at said at least one potential berthing location, wherein a relatively higher wind influence value indicates a lesser berthing feasibility and a relatively lower wind influence indicates a greater berthing feasibility; and determining, by the processing circuitry, the berthing feasibility for the marine vessel at said at least one potential berthing location based on its respective wind influence value.

The third aspect of the disclosure may seek to address the challenge of accurately determining safe and feasible berthing locations. A technical benefit may include enhanced decision-making for berthing operations by utilizing predictive wind data, offering improved safety and operational efficiency.

In a fourth aspect of the disclosure there is provided a computer-implemented method comprising obtaining a berthing feasibility for a second marine vessel based on a berthing feasibility determined for a first marine vessel according to the method of the third aspect, and optionally, obtaining vessel properties of the first marine vessel and adapting the obtained berthing feasibility based on vessel properties of the second marine vessel.

The fourth aspect of the disclosure may seek to address the challenge of accurately determining safe and feasible berthing locations. A technical benefit may include enhanced decision-making for berthing operations by utilizing predictive wind data, offering improved safety and operational efficiency.

In a fifth aspect of the disclosure there is provided a computer program product comprising program code for performing, when executed by the processing circuitry, the method of the third aspect.

The fifth aspect of the disclosure may seek to enable new marine vessels and/or legacy marine vessels to be conveniently configured, by software installation/update, to accurately determine safe and feasible berthing locations. A technical benefit may include enhanced decision-making for berthing operations by utilizing predictive wind data, offering improved safety and operational efficiency.

In a sixth aspect of the disclosure there is provided a non-transitory computer-readable storage medium comprising instructions, which when executed by the processing circuitry, cause the processing circuitry to perform the method of the third aspect.

The sixth aspect of the disclosure may seek to enable new marine vessels and/or legacy marine vessels to be conveniently configured, by software installation/update, to accurately determine safe and feasible berthing locations. A technical benefit may include enhanced decision-making for berthing operations by utilizing predictive wind data, offering improved safety and operational efficiency.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

There are also disclosed herein computer systems, control units, code modules, computer-implemented methods, computer readable media, and computer program products associated with the above discussed technical benefits.

### BRIEF DESCRIPTION OF THE DRAWINGS

Examples are described in more detail below with reference to the appended drawings.

FIG. 1 is an exemplary marine vessel according to an example.

FIG. 2 is an exemplary illustration of a nature landmass and how wind forecast data can affect potential berthing locations according to an example.

FIG. 3 is an exemplary illustration of a berthing map generated to show berthing feasibility of a marine vessel according to an example.

FIG. 4 is an exemplary flowchart illustration of a method for determining a berthing feasibility for a marine vessel according to an example.

FIG. 5 is an exemplary flowchart illustration of a method for obtaining a berthing feasibility for a marine vessel according to an example.

FIG. 6 is a schematic diagram of an exemplary computer system for implementing examples disclosed herein, according to an example.

### DETAILED DESCRIPTION

The detailed description set forth below provides information and examples of the disclosed technology with sufficient detail to enable those skilled in the art to practice the disclosure.

This disclosure addresses the challenges of berthing marine vessels in unpredictable and unstructured environments, such as natural landmasses without built harbors or docks. The process begins with obtaining localization data for berthing areas connected to natural landmasses, allowing for the identification of potential berthing locations. By integrating this data with wind forecast information for an upcoming berthing period, the system predicts the influence of wind on these locations. The wind forecast data is analyzed to determine a wind influence value for the vessel at each potential spot, where a higher value indicates lesser feasibility and a lower value indicates greater feasibility. This quantification enables a predictive and data-driven approach to berthing, allowing operators to make informed decisions that enhance safety and improve the berthing process. By forecasting and quantifying the impact of wind conditions, operators can avoid undesirable or dangerous spots due to changing environmental conditions, providing a forward-looking solution that enhances accuracy and reliability in both structured and unstructured marine environments.

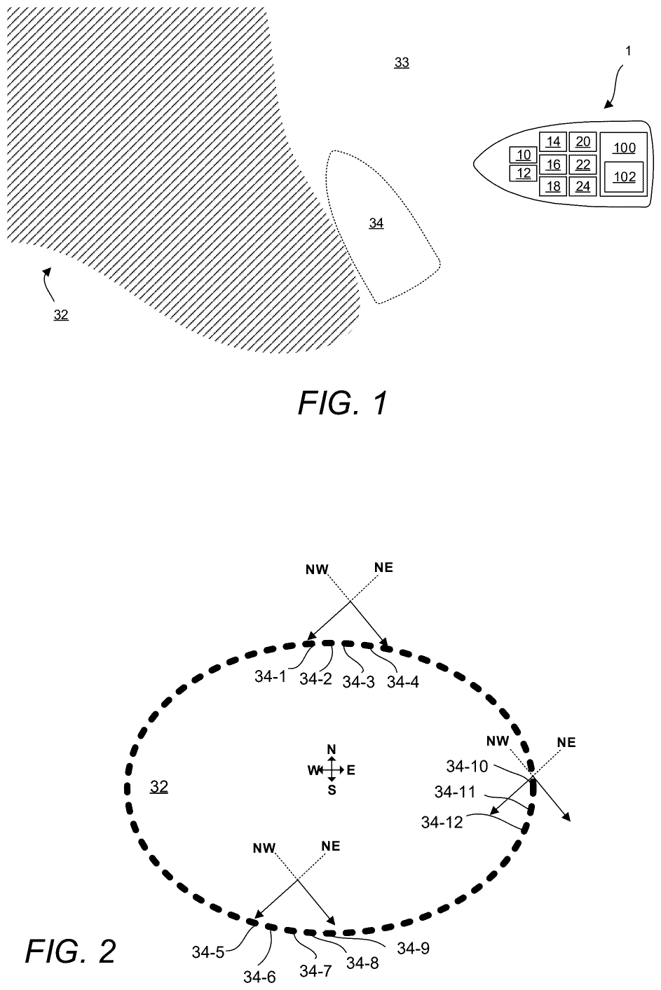

FIG. 1 is an exemplary marine vessel 1 where aspects and examples described herein can be applied. In non-limiting examples, the marine vessel 1 is a leisure boat, ship, cruise ship, fishing vessel, yacht, ferry, or the like. The marine vessel 1 is adapted to operate at bodies of water, e.g., a sea, ocean, lake, river, bay, gulf, strait, channel, reservoir, fjord, marsh, swamp, etc. The marine vessel 1 may be an electric marine vessel, gasoline-powered marine vessel, diesel-powered marine vessel, or the like.

The marine vessel 1 operates in environments that include one or more landmasses 32. A nature landmass 32 refers to any significant geographical feature that rises above the surface of the water and is formed by natural processes. Examples of nature landmasses include islands, peninsulas, and coastal regions that have not been significantly altered by human construction. These landmasses 32 are characterized by their organic topography, such as cliffs, beaches, and uneven coastlines, which can present unique challenges and opportunities for berthing marine vessels. This disclosure can also be applicable for nature landmasses 32 having docks or harbours, although the issue of nature berthing is arguably more pressing where there are no constructed barriers and/or predefined (human-made) berthing areas.

The marine vessel 1 is adapted to attempt berthing at one or more berthing areas 33 in connection with these nature landmasses 32. A berthing area 33 is a specific region near a nature landmass 32 where a vessel 1 can potentially anchor or dock. Typically, the berthing will be carried out at a certain distance from the nature landmass 32. This distance may be in direct mooring contact (i.e., at locations where it is possible to directly moor the marine vessel 1 on land), or at a distance from the nature landmass 32, i.e., an anchoring. In any event, both the anchoring and the direct mooring contact utilizes the fact that wind conditions will vary depending on how the marine vessel 1 is berthed in relation to the nature landmass 32. The berthing areas 33 are typically identified based on their proximity to the nature landmass 32, suitability for safe anchorage, and accessibility for the vessel. The size of a berthing area 33 can vary, ranging from small coves to expansive coastal stretches, depending on the data and calculations that will be discussed herein. The term “in connection with” broadly implies that the berthing areas 33 are directly influenced by the characteristics of the adjacent nature landmass 32, such as its shape, underwater terrain, and exposure to environmental conditions like wind and currents.

Within these berthing areas 33, the marine vessel 1 seeks out potential berthing locations 34. A potential berthing location 34 is therefore a specific spot within a berthing area 33 where the vessel can attempt to anchor or dock. The terms “potential” and “attempt to berth” indicate that these berthing locations 34 may appear suitable based on preliminary localization data, but their feasibility for actual berthing may vary depending on real-time conditions. Factors that qualify a spot as a potential berthing location 34 may be many and varied, but primarily relate to wind influence on the marine vessel 1 while being berthed at said location 34. Other conditions that can be considered involve seabed topography (such as water depth or underwater hazards), nature landmass topography (such as altitude above sea level of parts of the nature landmass 32), and vessel properties (such as accessibility for the vessel's 1 size and type). This will be discussed in more detail later on in this disclosure.

The identification of potential berthing locations 34 involves analyzing localization data. The localization data may be obtained from one or more of a distance sensor 10 and a sea chart service 12.

The marine vessel 1 comprises a distance sensor 10. This sensor is responsible for measuring the distance between the vessel 1 and surrounding objects, such as other vessels, landmasses, or underwater obstacles. The distance sensor 10 may be a lidar sensor, a radar sensor, a sonar sensor, or the like, or any combinations thereof. The distance sensor 10 is configured to obtain real-time distance measurements involving localization data. The localization data is obtained for one or more berthing areas 33 in connection with one or more nature landmasses 32, and assists in navigation to identify one or more potential berthing locations 34.

The marine vessel 1 comprises a sea chart service 12. The sea chart service 12 provides maps and charts of the sea, including information about water depths, navigational hazards, maritime routes, and other critical data such as buoy locations and lighthouse positions. The sea chart service 12 may be continuously updated with the latest navigational information, ensuring that the vessel 1 has access to the most current data. The sea chart service 12 may assist in voyage planning by allowing the crew to plot safe and efficient paths through various water bodies, taking into account known hazards and optimal routes. The sea chart service 12 is useful for avoiding shallow areas, rocky outcrops, and other dangers that could compromise the vessel's 1 safety.

The at least one potential berthing location 34 may be identified based on a user request or an automatic system trigger. When operating in a user-request mode, the vessel's 1 operator can manually perform a prompt, for example via a human-machine interface, to search for suitable berthing locations within a specified area 33 or under certain conditions. This may allow the operator to leverage vessel systems for attempting to find advantageous berthing spots based on for example real-time inputs and navigational needs.

Alternatively, automatic mode operation can also be envisaged, where an automatic system trigger initiates the identification process. This trigger can be activated by predefined conditions, such as reaching a certain distance from a landmass, specific time intervals, or environmental thresholds like wind speed or sea state.

In some examples, the automatic system trigger for identifying at least one potential berthing location 34 is based on historical berthing data. A database of past berthing events may be utilized for this purpose, which can include information about previously used berthing locations, environmental conditions at the time, and the outcomes of those berthing attempts. The historical data may be analyzed to recognize patterns and determine most favorable berthing spot(s) under similar conditions. For example, if the vessel 1 has successfully berthed in a particular berthing location 34 multiple times under specific wind and sea conditions, this historical data may be utilized to trigger identification of that location as a potential berthing location 34 when similar conditions arise. This approach may leverage the accumulated experience of past operations, reducing the reliance on real-time decision-making and increasing the likelihood of selecting safe and effective berthing locations. The historical data may be obtained from a central server (i.e., collected by other vessel), or relate to past experiences of the vessel 1 itself.

The marine vessel 1 further comprises a weather forecast service 14. The weather forecast service 14 delivers up-to-date weather forecast data, specifically including forecasts for wind as wind forecast data. The weather forecast data may also include forecasts for precipitation, temperature, wave heights, and other meteorological conditions that can affect berthing. Indirectly, the wind forecast data and the other weather forecast data affects other conditions of the sea such as currents, waves, etc. By utilizing the weather forecast service 14, the vessel 1 can anticipate and prepare for weather changes, which is important for safe berthing. The wind forecast data provides short-term and long-term forecasts, enabling the crew to make informed about berthing.

Some exemplary formats for obtaining the wind (and optionally weather) forecast data may include General Regularly-Distributed Information in Binary form (GRIB) and the World Meteorological Organization (WMO) standard format for achieving and exchanging gridded data. The GRIB format is a concise data format commonly used in meteorology to store and transmit weather data. It allows for the efficient representation of complex meteorological data, such as wind speed, direction, temperature, and pressure, across a regularly spaced grid. Obtaining weather forecast data in the GRIB format may allow for handling of large volumes of detailed weather information with high spatial and temporal resolution such that more accurate predictions about future weather conditions affecting potential berthing locations 34 can be done The WMO standard format for achieving and exchanging gridded data is another format used for transmitting meteorological information. This format adheres to international standards set by the WMO, ensuring consistency, accuracy, and interoperability across different meteorological services and systems. By utilizing the WMO standard format, the weather forecast data is guaranteed to be as reliable as possible and compatible with other meteorological datasets and services. This standardization is crucial for integrating diverse sources of weather data and providing a comprehensive overview of the environmental conditions.

Obtaining forecasts of future wind conditions, particularly long-term forecasts, is used for assessing whether the wind is expected to change during the time when the marine vessel 1 is berthing at a potential berthing location 34. For instance, if the wind changes direction from west to east overnight, this shift can impact the feasibility of a previously selected potential berthing location 34. Initially, a potential berthing location 34 may be deemed suitable when the wind is coming from the west where a nature landmass 32 provides shelter and calm conditions. However, as the wind shifts to come from the east, it may start blowing towards the nature landmass 32, making the once safe berthing location more exposed to rougher conditions and potentially hazardous. This ability to forecast and anticipate wind changes over time can ensure that the vessel 1 can select berthing locations 34 that remain safe throughout the entire berthing period. By understanding how wind conditions are expected to evolve, the crew can avoid spots that may become undesirable or dangerous due to changing wind directions. This foresight is particularly important in natural docking scenarios where there are no man-made structures to provide additional protection against the elements. Long-term wind forecasts allow for proactive decision-making, enhancing the safety and efficiency of the berthing process by enabling the vessel 1 to adapt to dynamic environmental conditions.

The concept of an “upcoming berthing time period” is utilized herein to plan and execute safe berthing operations. The upcoming berthing time period refers to the specific duration during which the vessel 1 intends to berth at a particular location. This period can vary based on several factors, including the vessel's 1 schedule, the nature of the cargo, and external conditions such as weather forecasts. The wind forecast data for the upcoming berthing time period is therefore used for anticipating and preparing for environmental changes that might affect the vessel's 1 safety and stability while berthed. For example, a vessel 1 might plan to berth overnight, from 20:00 to 06:00, which constitutes a ten-hour upcoming berthing time period. During this time, the vessel 1 is preferably remained securely anchored or moored, with limited risk from shifting winds, tides, or other environmental factors.

The wind forecast data is also “expected” for the vessel 1 at the location. This means that the vessel 1 does not necessarily berth at the potential berthing location 34, at least initially, because certain calculations need first to be made to establish its berthing feasibility. For instance, if the vessel 1 is expected to berth at a coastal bay, the environmental conditions at that bay during the overnight period are assessed to ensure that they remain favorable throughout the entire duration.

Determining the upcoming berthing time period can be done automatically or manually. In an automatic determination, the desired berthing duration can be automatically calculated based on factors such as the vessel's 1 estimated time of arrival at a certain location 34, unloading or loading schedules, historical data of previous berthing periods, and weather forecast data. For example, if a weather window of calm conditions is identified for six hours, it might automatically set this as the upcoming berthing time period. Alternatively, the berthing time period can be manually determined by the vessel's 1 operator based on known operational needs. For instance, if the operator knows that berthing will occur overnight due to scheduling requirements, they can manually set the upcoming berthing time period from dusk to dawn.

In addition to the aforementioned components, this exemplary marine vessel 1 includes a seabed topology service 16 and a landmass topology service 18. The seabed topology service 16 provides information about the seabed's physical characteristics, such as underwater terrain, slopes, and potential hazards like submerged rocks or wrecks. The seabed topology service 16 may use data from sonar mapping (for example the distance sensor 10 being a sonar sensor), satellite imagery, and/or hydrographic surveys to create accurate representations of the underwater environment. This information can potentially be decisive for anchoring and berthing in unfamiliar or unstructured locations, as it helps the crew understand the depth variations and identify safe anchorage points. Knowledge of the seabed topology may also be important for avoiding grounding and ensuring the vessel's 1 operational safety.

The seabed topology service is advantageously used in combination with vessel properties of the marine vessel 1. By knowing the seabed topology service, such as the depth at a certain potential berthing location 34, and knowing the depth of the hull of the marine vessel 1, a berthing location 34 may discarded if it does not allow for the depth of the hull.

This landmass topology service 18 offers data about the physical features of nearby nature landmasses 32, including their shapes, elevations, coastal contours, and any significant geographical features such as cliffs, bays, and inlets. The landmass topology service 18 may use data from topographic surveys, satellite imagery, and aerial photography to provide accurate and comprehensive information. Understanding the surrounding terrain may be used for identifying safe berthing locations 34, planning entry and exit routes, and assessing how the landscape might influence wind patterns and sea conditions. This knowledge helps in making informed decisions about where to dock and how to approach various coastal areas.

Consider a scenario where the marine vessel 1 plans to berth near a rugged coastal region with a series of cliffs and valleys. The landmass topology service 18 provides topographical data of this coastal area, detailing the elevations and contours of the cliffs, the shape of the valleys, and/or the overall layout of the coastline. Using this topographical data, it can be analyzed for the landscape might influence local wind patterns. For instance, it may be identified that the cliffs create a natural barrier that blocks prevailing winds from the west, providing a sheltered area on the leeward side. Conversely, valleys might act as wind funnels, where the wind speed increases as it is channeled through narrow passages.

By overlaying this topographical information with the wind forecast data obtained in GRIB or WMO standard formats, predictions on how the wind patterns will interact with the landscape over the upcoming berthing time period can be made. For example, if the weather forecast indicates that the wind will shift from west to east overnight, this change may observed with respect to influence on the sheltered area behind the cliffs. Initially, the berthing location might be ideal with west-side winds providing protection. However, once the winds shift to the east, the cliffs no longer offer shelter, and the previously calm area might become exposed to direct winds and choppy sea conditions.

Moreover, as the wind forecast data indirectly can affect sea conditions such as wave heights and currents, cliffs of the nature landmass 32 might reduce wave action in the sheltered area, making it a suitable berthing spot when the wind is from the west. However, the eastward wind shift might lead to increased wave heights and turbulent waters in the same area, making it less feasible for safe berthing

By combining the landmass topology data with dynamic weather forecasts, a comprehensive assessment of potential berthing locations 34 can be provided. This can allow for the vessel 1 to anticipate and adapt to changing conditions, ensuring that the selected berthing spot remains safe and suitable throughout the entire berthing period.

The marine vessel 1 may also include an Automatic Identification System (AIS) service 20. The AIS service 20 provides real-time information about other vessels in the vicinity, including their positions, courses, speeds, and identification details such as vessel names and types. The AIS service 20 operates using VHF radio signals to transmit and receive data between vessels and coastal stations. By using the AIS service 20, AIS data obtained therefrom may contribute to assessing berthing feasibility by providing insights into the traffic patterns and activities of other vessels near potential berthing locations 34. For instance, if the AIS data indicates that a particular location will experience heavy ferry traffic during the upcoming berthing time period, this information can be used for decision-making. Ferries passing by frequently can generate waves and turbulence, leading to unstable conditions that could compromise the safety and stability of the berthed vessel 1.

In view of the above, many potential berthing locations 34, which would otherwise be ideal, are often underutilized due to concerns about heavy traffic and resultant wave action. By considering the proximity of a location to major shipping lanes, the AIS system may enhance decision-making processes further.

Following the example discussed above, the AIS data can be integrated with the landmass topology data and weather forecast data for improving the berthing feasibility determination. For example, the landmass topology might suggest that a certain cove can provide good shelter from predicted winds, making it initially appear as an ideal berthing spot. However, if the AIS data reveals that multiple ferries are scheduled to pass by the entrance of the cove during the same period, the resulting wave action could create challenging conditions, reducing the overall feasibility of that location for safe berthing. To this end, another berthing location 34 can be prioritized which is less affected by vessel traffic.

The marine vessel 1 further comprises a display device 22. The display device 22 is configured to present real-time navigational data, weather forecasts, and berthing feasibility analyses to the vessel's 1 crew. The display device 22 provides a visual interface for monitoring and interacting with various onboard systems, ensuring that the crew can make informed decisions based on the latest information.

The marine vessel 1 further comprises a communication device 24. The communication device 24 is configured to enable communication with other vessels, coastal stations, and maritime authorities. The communication device 24 supports the transmission and reception of data, such as AIS information, weather updates, and emergency signals, ensuring that the vessel 1 maintains connectivity and coordination with external entities.

The marine vessel 1 further comprises a computer system 100 having processing circuitry 102. The computer system 100 serves as the central processing unit for integrating and analyzing data from various sensors and services, such as the components 10, 12, 14, 16, 18, 20, 22 and 24 discussed above. The processing circuitry 102 includes processors, memory, and communication interfaces to execute algorithms and software applications that support the determination of the berthing feasibility. The processing circuitry 102 is therefore configured to obtain localization data of one or more berthing areas 33 in connection with one or more nature landmasses 32. The processing circuitry 102 is further configured to, based on the localization data, identify at least one potential berthing location 34 where the marine vessel 1 can attempt to berth within the berthing areas 33. The processing circuitry 102 is further configured to obtain wind forecast data for an upcoming berthing time period expected for the marine vessel 1 at said at least one potential berthing location. The processing circuitry 102 is further configured to obtain wind forecast data (and optionally other weather forecast data) for an upcoming berthing time period expected for the marine vessel 1 at said at least one potential berthing location 34. Other actions carried out by the processing circuitry 102 involve the determination of a wind influence value and, based thereon, the determination of the berthing feasibility. This will now be discussed with further reference to FIG. 2.

FIG. 2 illustrates a nature landmass 32 in the form of a generally circular island, surrounded by various potential berthing locations 34 indicated by dots. The figure includes a compass showing the cardinal directions (N, W, S, E) and an arrow indicating the wind direction, which is forecasted to blow towards the island from between the northwest (NW) and northeast (NE) during an upcoming berthing time period.

The northern side of the island has four potential berthing locations 34-1, 34-2, 34-3, 34-4. Given the wind is expected to reach the island from the NW to NE range, these northern berthing locations will be directly exposed to the incoming wind. This exposure can lead to turbulent sea conditions, making it more challenging for the vessel to berth safely. The wind can cause increased wave action and destabilize the vessel, reducing the feasibility of these northern spots for berthing during the forecasted wind conditions.

The eastern side of the island has three potential berthing locations 34-10, 34-11, 34-12. These locations are also within the range affected by the incoming wind from the NW to NE. Although the eastern berthing spots may not be as directly exposed as the northern ones, they will still experience wind impact. The wind blowing across the island can create choppy waters and swirling currents around these spots, potentially making them less stable and more challenging for berthing.

The southern side of the island has five potential berthing locations 34-5, 34-6, 34-7, 34-8, 34-9. These locations are on the leeward side of the island relative to the forecasted wind direction. Being sheltered by the landmass 32, the southern berthing spots will be less affected by the incoming wind. The island's topography will block much of the wind's force, resulting in calmer waters and more stable conditions. Therefore, these southern berthing locations are likely to be more feasible and safer for berthing during the forecasted wind conditions.

In determining the berthing feasibility for the marine vessel 1, the wind forecast data is first obtained and utilized to calculate a wind influence value for each potential berthing location 34 during the estimated upcoming berthing time period. This calculation is proactive, meaning that it is done before the marine vessel 1 reaches the berthing locations 34, thus allowing for selective and preemptive determination for a plurality of different berthing locations 34. The wind influence value quantifies the impact of wind conditions on the vessel's 1 ability to berth safely and effectively. The berthing feasibility for each potential berthing location 34 is assessed based on its respective wind influence value. Locations with lower wind influence values are considered more feasible for berthing, as they offer safer and more stable conditions. Locations with higher wind influence values are deemed less feasible due to the increased risk of rough conditions and instability caused by the wind.

For each potential berthing location 34, a wind influence value is calculated. As discussed above, this is based on the wind forecast data and the localization data. Generally, this includes factors such as exposure to wind, shelter from landmass, wind speed and gusts, and duration of wind impacts. Locations directly in the path of strong winds (e.g., northern and eastern spots in FIG. 2) will have higher wind influence values. Locations shielded by the landmass (e.g., southern spots in FIG. 2) will have lower wind influence values. Higher wind speeds and frequent gusts increase the wind influence value. Sustained winds over the berthing period will raise the wind influence value.

The wind influence value is a relative measure where a higher value indicates greater wind impact and, consequently, lesser feasibility for safe berthing. Conversely, a lower wind influence value suggests that the location is more sheltered and stable, indicating greater berthing feasibility. The wind influence value may comprise one or more numerical thresholds or ranges that correlate to different levels of feasibility for safe berthing. For example, the wind influence value may be a quantified measure determined by specific wind conditions at a berthing location 34. The wind influence value may be expressed as a numerical score comprising one or more limit values, for example ranging from 0 to 100 or 0 to 5. For example, wind speeds are measured in knots, and direction is measured in degrees from true north.

Purely by way of example, a wind influence value of zero to a first limit value (such as 0-20 in a scale of 100 or 0-1 in a scale of five) may indicate wind impact, suggesting that the location is highly feasible for safe berthing. A wind influence value between the first limit value and a second limit value (such as 21-40 or 1-2 in the scales above) indicates moderate wind impact, suggesting that the location is reasonably feasible for safe berthing but may require additional caution. A wind influence value between the second limit value and a third limit value (such as 41-60 or 2-3 in the scales above) indicates significant wind impact, suggesting that the location is less feasible for safe berthing and may pose stability challenges. A wind influence value between the third limit value and a fourth limit value (such as 61-80 or 3-4 in the scales above) indicates high wind impact, suggesting that the location is minimally feasible for safe berthing and poses substantial stability risks. A wind influence value between the fourth limit value and a maximum limit value (such as 81-100 or 4-5 in the scales above) indicates extreme wind impact, suggesting that the location is not feasible for berthing due to severe stability risks.

Using the exemplary definition above, a potential berthing location 34 could be considered where the average wind speed is forecasted to be 25 knots from the northwest (315 degrees) over the upcoming berthing period. The processing circuitry 102 may employ a predefined algorithm to assign a wind influence value based on these conditions. If the algorithm determines that these wind conditions correspond to a wind influence value of 75, this indicates high wind impact and minimal feasibility for safe berthing.

In some examples, determining the wind influence value may involve obtaining and analyzing wind forecast data represented as a plurality of wind vectors. Each wind vector provides information about the wind conditions, specifically comprising a direction and a magnitude of wind influence on the marine vessel 1 for a predetermined time sequence during the estimated upcoming berthing time period.

A wind vector may be defined as a mathematical representation of wind conditions at a specific point in time. It has two main components: direction and magnitude. The direction indicates the angle at which the wind is blowing relative to a fixed reference point, typically measured in degrees from true north (e.g., a wind direction of 90 degrees indicates wind blowing from the east). The magnitude represents the strength or speed of the wind, usually measured in units such as meters per second (m/s) or knots. Together, these components provide a comprehensive description of the wind's behavior at a given time.

The wind forecast data is obtained in segments corresponding to a predetermined time sequence. This sequence is typically dictated by the format in which the data is received from the weather forecast service 14. For example, wind forecast data might be provided in one-hour segments, where each segment includes wind vectors specifying the expected wind direction and magnitude for that hour. Thus, for an upcoming berthing time period of 12 hours, the system would receive 12 sets of wind vectors, each representing the forecasted wind conditions for one of those hours.

The processing circuitry 102 obtains these wind vectors in a structured format, and they may optionally be stored within a database or an in-memory data structure designed for retrieval and analysis. This may allow past wind conditions to be referenced and/or compared with current forecasts. Moreover, the processing circuitry 102 may identify trends, such as gradual increases in wind speed or shifts in wind direction, which may then be used for predicting future conditions. Furthermore, the wind vectors enables the processing circuitry 102 to perform subsequent calculations and/or simulations to assess wind influence on the marine vessel 1 over time.

Once the wind vectors are obtained (and optionally stored), the processing circuitry 102 is configured to analyze them to determine the wind influence value for each potential berthing location 34. This analysis involves evaluating how the direction and magnitude of the wind will affect the vessel's 1 stability and safety during the upcoming berthing time period.

Consider a scenario where the marine vessel 1 plans to berth on the northern side of the island 32 over the next 12 hours. The wind forecast data provides wind data in one-hour segments, resulting in 12 wind vectors. One of these vectors might indicate a wind direction of 315 degrees (northwest) with a magnitude of 15 knots for the first hour. The processing circuitry 102 may store this vector along with the other 11 vectors representing the subsequent hours. By analyzing the sequence of wind vectors, the system can determine that the northern side will experience strong, persistent winds from the northwest, leading to a higher wind influence value and lower berthing feasibility.

In assessing berthing feasibility and safety, not only is the wind direction relative to nearby landmasses 32 considered, but also the wind's orientation relative the vessel's 1 positioning. For example, in smaller leisure boats, the wind's impact can vary depending on how the boat is anchored. For instance, if a vessel is anchored from the stern, having the wind blow directly towards the stern is undesirable unless the wind's magnitude is low. This positioning can lead to instability and potential safety hazards as the wind exerts force on the boat's rear. Similarly, receiving wind from the side of the vessel can be problematic unless proper measures, such as attaching a spring line, are in place to absorb some of the force. When a boat lies broadside, the side-on wind impact is less of an issue because the vessel's orientation allows it to better handle lateral forces. Thus, the wind's direction relative to both the landmasses 32 and the vessel's 1 anchoring and/or orientation may be considered.

In some examples, the processing circuitry 102 is configured to analyze the stored wind vectors by adjusting the wind influence value for a particular berthing location 34 based on the direction of the wind relative to the nature landmass 32. First, the wind forecast data for that particular berthing location 34 is obtained as a plurality of wind vectors for the upcoming berthing time period. The wind influence value is increased where the direction of the wind points towards the nature landmass 32. This situation typically occurs when the wind is blowing from the sea towards the land, resulting in increased wave action and turbulence at the berthing location. For example, if the wind vector indicates a wind direction of 315 degrees (northwest) and the potential berthing location is on the northern side of the island, the wind is blowing towards the landmass. This exposure increases the wind influence value, indicating greater wind impact and reduced berthing feasibility. Conversely, the wind influence value is decreased where the direction of the wind points away from the nature landmass 32. This situation occurs when the wind is blowing from the land towards the sea, providing a sheltered environment at the berthing location. For instance, if the wind vector indicates a wind direction of 135 degrees (southeast) and the potential berthing location is on the northern side of the island, the wind is blowing away from the landmass. This sheltered condition decreases the wind influence value, indicating lesser wind impact and increased berthing feasibility.

Consider a scenario where the marine vessel 1 plans to berth on the northern side of the island 32 over the next 12 hours. The wind forecast data provides 12 wind vectors, each representing wind conditions for one-hour segments. Suppose the first wind vector indicates a wind direction of 315 degrees (northwest). The processing circuitry 102 identifies that the wind is blowing towards the northern side of the island, where the potential berthing location is situated. Therefore, the wind influence value for this location is increased to reflect the higher wind impact. In contrast, suppose another wind vector for a different time segment indicates a wind direction of 135 degrees (southeast). In this case, the wind is blowing away from the northern side of the island. The processing circuitry 102 decreases the wind influence value for the northern berthing location, reflecting the reduced wind impact and more sheltered conditions. In this sense, the wind influence value may be based on how many instances of unfavorable wind (i.e. wind pointing towards the landmass 32) there are present in the wind vectors in relation to how many instances of favourable wind there are (i.e. wind point away from the landmass 32), where an instance correspond to a wind vector for a certain time sequence. To this end, the example of eleven wind vectors pointing towards the landmass 32 and one wind vector pointing away from the landmass 32 would likely result in a low berthing feasibility in case the direction serves as the main decisive factor.

In some examples, the processing circuitry 102 is configured to analyze the stored wind vectors by adjusting the wind influence value for a particular berthing location 34 based on the magnitude of the wind relative to a predefined wind tolerance value. First, the wind forecast data for that particular berthing location 34 is obtained as a plurality of wind vectors for the upcoming berthing time period. The wind influence value is increased where the magnitude of the wind vector exceeds the first wind tolerance value. This condition indicates that the wind speed is high enough to negatively impact the stability and safety of said particular berthing location 34. For example, if the first wind tolerance value is set at 15 knots, any wind vector with a magnitude greater than 15 knots will result in an increased wind influence value. This adjustment reflects the higher wind impact and reduced feasibility for safe berthing. Conversely, the wind influence value is decreased where the magnitude of the wind vector is less than the first wind tolerance value. This condition indicates that the wind speed is relatively low and unlikely to pose significant challenges to the particular berthing location 34. For instance, if the first wind tolerance value is 15 knots, any wind vector with a magnitude less than 15 knots will lead to a decreased wind influence value. This adjustment reflects the lower wind impact and increased feasibility for safe berthing.

Consider a similar scenario as the direction-based calculation above, i.e., a scenario where the marine vessel 1 plans to berth on the northern side of the island 32 over the next 12 hours. The wind forecast data provides 12 wind vectors, each representing wind conditions for one-hour segments. Suppose the first wind vector indicates a wind direction of 315 degrees (northwest) with a magnitude of 20 knots. The processing circuitry 102 compares this magnitude to the first wind tolerance value of 15 knots. Since 20 knots exceeds the tolerance value, the wind influence value for the northern berthing location is increased to reflect the higher wind impact and reduced feasibility. In contrast, suppose another wind vector for a different time segment indicates a wind direction of 135 degrees (southeast) with a magnitude of 10 knots. The processing circuitry compares this magnitude to the first wind tolerance value of 15 knots. Since 10 knots is less than the tolerance value, the wind influence value for the northern berthing location is decreased, reflecting the lower wind impact and increased feasibility.

While a first wind tolerance value is defined above, this may be expanded to include a plurality of wind influence values, optionally with different relative increases among the different wind influence values. In this enhanced approach, instead of using a single threshold to evaluate wind impact, multiple wind tolerance values are employed, each representing different levels of wind influence severity. For example, the system might define three wind tolerance values: 10 knots, 20 knots, and 30 knots. Each of these values corresponds to different levels of wind impact, allowing for a more granular assessment of berthing feasibility. When analyzing the wind vectors, the processing circuitry 102 can apply these multiple wind tolerance values to determine the wind influence at potential berthing locations. If the wind magnitude exceeds the lowest threshold (e.g., 10 knots), a moderate wind influence value is assigned. If the wind magnitude exceeds the next threshold (e.g., 20 knots), a higher wind influence value is assigned. If the wind magnitude exceeds the highest threshold (e.g., 30 knots), the highest wind influence value is assigned, indicating severe wind impact. This multi-tiered approach may allow for an increased differentiation between varying degrees of wind severity and adjust the wind influence values accordingly to provide a more nuanced evaluation of berthing conditions. This flexibility may allow for more precise berthing decisions, enhancing safety and operational efficiency by accounting for varying wind conditions and their relative effects on different potential berthing locations.

In some examples, the processing circuitry 102 is configured to analyze the stored wind vectors by comparing the magnitudes of the wind influence for the marine vessel 1 with respect to (one or more) different potential berthing locations 34. The analysis in these examples thus involves performing a relative weighing of the wind influence value among these different potential berthing locations 34 based on the comparison of wind magnitudes. First, the wind forecast data for that particular berthing location 34 is obtained as a plurality of wind vectors for the upcoming berthing time period. The processing circuitry 104 then compares the magnitudes of the wind vectors for each potential berthing location to evaluate which berthing locations 34 will experience higher or lower wind impacts.

For instance, suppose there are three potential berthing locations of the north side of the island 32, i.e., the locations 34-1, 34-2, and 34-3. The wind forecast data in this example indicates the following wind magnitudes for these locations over the upcoming berthing period: Location 34-1: 20 knots, location 34-2: 15 knots, and location 34-3: 25 knots. Based on the comparison of wind magnitudes, the processing circuitry 102 performs a relative weighing of the wind influence values among the different berthing locations 34-1, 34-2, 34-3. This involves assigning a higher relative wind influence value to locations with greater wind magnitudes and a lower relative wind influence value to locations with lesser wind magnitudes. The relative weighing ensures that the location with the highest wind impact (location 34-3) is identified as less feasible for safe berthing. Conversely, the location with the lowest wind impact (location 34-2) is identified as more feasible for safe berthing. This comparative analysis allows the vessel's crew to make informed decisions about which berthing location offers the best conditions based on the relative wind influence.

The relative weighing helps prioritize the berthing locations based on their expected wind impact, and need not necessarily rely on wind tolerance values. As such, a distinction between various different berthing locations 34 can be made even if their respective wind impacts are relatively close to one another. By comparing wind magnitudes and performing relative weighing of wind influence values, a more nuanced and context-sensitive assessment of berthing feasibility can be provided.

In some examples, the stored wind vectors may be analyzed by omitting potential berthing locations 34 where the direction of the wind influence points towards the nature landmasses 32 and the magnitude of the wind influence is greater than a second wind tolerance value. The second wind tolerance value may be the same as the first wind tolerance value, or different. It is typically lower, as direct incoming wind towards the landmass 32 are typically associated with poor berthing feasibility. This process can ensure that berthing locations 34 which are exposed to strong and direct wind impacts are excluded from consideration, thereby enhancing the safety and feasibility of the selected berthing spots. This also allows for the analysis to be quicker, as possibly a large number of potential spots can be discarded directly before any computing needs to be carried out.

In some examples, the berthing feasibility determination may be incorporated into an advanced driver assistance system (ADAS) on the marine vessel 1. The ADAS utilizes the calculated wind influence values for potential berthing locations 34 to automatically update and improve the vessel's 1 navigation route. When the berthing location 34 with the highest feasibility is determined based on the wind influence values, the course of the vessel 1 can be seamlessly adjusted to navigate directly to this preferred berthing location 34. This integration can ensure that the vessel 1 arrives at the safest and most stable location for berthing, enhancing overall safety and efficiency.

In more advanced examples, the berthing feasibility determination extends beyond merely selecting a berthing spot; it plays a role in the vessel's 1 broader navigational strategy. As wind conditions are assessed across various potential berthing areas 33, the wind impact on different navigational routes in the vicinity of the potential berthing locations 34 can also be assessed. This information may enable the ADAS to choose routes that minimize exposure to adverse wind conditions, thus avoiding excessive wind and ensuring smoother and safer voyages.

For instance, in the context of FIG. 2, if the ADAS determines that the northern side of the island 32 faces strong winds from the NW to NE, it can recommend navigating around the southern side of the island 32 instead. By driving south, the vessel 1 can stay in calmer waters, protected from the direct impact of the wind by the landmass of the island 32. This strategic route selection based on wind influence values may thus not only improve berthing feasibility, but also the overall navigation experience by reducing the risk of encountering rough seas and unstable conditions.

As discussed above, topography data may also play a role in determining the berthing feasibility. Two examples are envisaged: seabed topography data-based berthing feasibility determination and landmass topography-based berthing feasibility determination.

The seabed topography data includes information about the depth, slope, and features of the seabed, such as rocks, sandbanks, and underwater obstacles. The processing circuitry 102 obtains this data, for example from a seabed topography service, and integrates it with the vessel's 1 properties, such as draft, length, and hull shape. By analyzing this combined data, assessments whether the seabed conditions are suitable for safe berthing can be done. For instance, a location with a shallow depth might pose grounding risks for a vessel 1 with a deep draft, resulting in lower berthing feasibility. Conversely, a location with a flat, deep seabed might be ideal, indicating higher berthing feasibility. This comprehensive analysis ensures that the vessel can berth safely, avoiding underwater hazards and ensuring stability.

The landmass topography data includes information about the elevation, shape, and contours of the land, such as cliffs, hills, and coastal formations. The processing circuitry 102 obtains this data, for example from a landmass topography service, and analyzes how these features might impact berthing conditions. For example, high cliffs might provide shelter from strong winds, increasing berthing feasibility, while low-lying areas might offer little protection, reducing feasibility. Additionally, the shape of the coastline can influence wave patterns and currents, affecting the stability of the potential berthing location 34. By integrating landmass topography data into the analysis, a more holistic assessment of berthing feasibility can be obtained, ensuring that the chosen potential berthing location 34 offers improved protection and stability based on the surrounding terrain.

In some examples, the processing circuitry 102 can be configured to control an alarm system that activates an alarm when there is a change in the wind forecast data exceeding a predefined limit value. This capability can ensure that any alterations in wind conditions, which could impact the previously determined berthing feasibility, are promptly communicated to the crew. The system 100 may continuously monitor wind forecast data even after the initial berthing feasibility assessment has been made. If a change in wind conditions is detected that surpasses the limit value—indicating that it is no longer safe to berth at a location previously deemed feasible—the alarm system is triggered. This can occur at any time regardless of whether the vessel 1 is en route to the berthing location or already berthed. For instance, if the wind forecast changes unexpectedly overnight, causing increased wind speeds or a shift in direction that compromises the berthing location's safety, the alarm system will activate.

The alarm can be delivered through various means, such as an audio alert via a horn or a visual signal on a display. It can also be sent as a notification to a crew member's phone. This proactive alert mechanism can enhance safety by ensuring that the crew is immediately informed of any critical changes in environmental conditions, allowing them to take necessary actions to safeguard the vessel and its occupants.

In some examples, the open sea influence can affect the berthing feasibility. Even if a berthing location 34 is deemed suitable based on wind and land conditions, the presence of large open waters nearby can have a negative impact. This is particularly true if there have been strong winds in a certain direction in previous days, generating residual waves known as swell that persist regardless of the current wind direction. By incorporating open sea data for a particular previous time period, the system 100 can provide a more comprehensive assessment of berthing feasibility which may add on to the safety and operational efficiency.

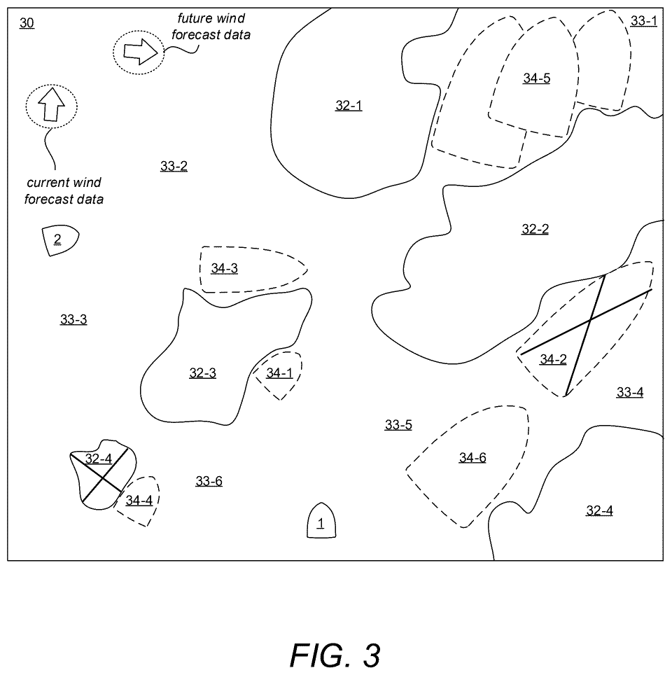

Reference is now made to FIG. 3, showing an exemplary navigational context for a marine vessel 1. A marine vessel 1 operates in a geographical area that includes both sea and islands/landmasses 32. The figure provides a view of how the vessel 1 can use localization data and wind forecast data to determine the feasibility of various potential berthing locations 34 during an upcoming berthing time period. In the top left corner of FIG. 3, it is indicated that the wind is currently coming from the south. However, future wind forecast data suggests that the wind direction will shift to come from the west. This change in wind direction is used for the vessel's 1 berthing decision-making process. It shall be noted that this is but one exemplary navigational scenario, and different geographical locations will of course appear different with different numbers of navigable areas, berthing locations, landmasses, wind conditions, topography data, and so forth, and may be of any realistic size to offer berthing possibilities for a marine vessel 1.

The localization data identifies several navigable areas 33-1 to 33-6, each offering different degrees of suitability for berthing. Within these navigable areas, several potential berthing locations 34-1 to 34-6 are identified. The vessel's 1 goal is to assess whether these potential berthing locations 34-1 to 34-6 are not only theoretically suitable but actually feasible for safe berthing. Using the teachings discussed herein, an analysis of each berthing location 34-1 to 34-6 is carried out, considering factors such as wind influence, landmass topography, and seabed topography. After completing this analysis, the determination that certain spots are feasible or not is provided, and potential omissions of berthing locations 34-1 to 34-6 can be carried out.

In this particular example, the berthing location 34-2 is found to be not feasible due to the seabed topography of area 33-4. The characteristics of the vessel's 1 hull did not work well with the shallow and/or uneven seabed surface, posing risks of grounding and instability. The berthing location 34-4 is also deemed not feasible. The landmass topography of island 32-4 was deemed very low, offering essentially no wind shelter from the future wind expected to come from the west. This lack of protection makes the spot vulnerable to rough conditions.

On the other hand, the berthing location 34-5 within area 33-1 was identified as highly feasible. The landmass 32-1 provides appropriate wind shelter from the west, creating a stable and protected environment for the vessel. Moreover, since the gap between the landmasses 32-1 and 32-2 is rather narrow, there is also wave protection in the area 33-1. The berthing location 34-1 was also deemed feasible but to a lesser extent than the berthing location 34-5. The island 32-3 is smaller than island 32-1, offering less wind protection. Nevertheless, it still provides sufficient shelter for safe berthing. The berthing locations 34-3 and 34-6 are determined to be decently feasible, not primarily due to wind direction but because of the gentle winds with low speeds expected overnight. These conditions reduce the overall wind impact, making these locations suitable for berthing.

The view shown in FIG. 3 may be presented to the operator of the marine vessel 1 as navigational and/or berthing guidance. To this end, the processing circuitry 102 may be configured to generate a berthing map 30 being a virtual representation of the berthing areas 33 and the nature landmasses 32. Moreover, the berthing map 30 involves one or more graphical indications of the berthing feasibility for the marine vessel 1. The processing circuitry 102 may be configured to control a display device 22 of the marine vessel 1 to present the berthing map 30, such that the operator is presented with a visual overlay of the environment. By integrating localization data, wind forecast data, and topographical information, the berthing map 30 provides a comprehensive overview of the potential berthing locations 34, allowing the vessel's 1 crew to quickly assess and compare the suitability of different berthing locations 34.

The graphical indications on the berthing map 30 may be highlighted according to the order of the berthing feasibility. This means that the visual representations on the berthing map 30 are adjusted to reflect the relative wind impact on each potential berthing location 34. Locations with higher wind influence values, indicating less favorable conditions, may be distinctly marked, while those with lower wind influence values, indicating more favorable conditions, may be highlighted differently. This feature may assist the crew to prioritize safer and more stable berthing locations 34 at a glance.

The graphical indications may be further refined using polygons whose sizes are determined based on the order of the berthing feasibility. Specifically, the size of each polygon on the berthing map 30 correlates with the wind influence value—lesser wind influence values result in larger polygons, while higher wind influence values result in smaller polygons. An example of this is the berthing location 34-5 in FIG. 3, presenting the size in a boat-shaped polygon being significantly larger than the other berthing locations 34-5 to indicate its relatively higher berthing feasibility. This visual scaling may provide an intuitive and immediate understanding of the relative feasibility of each berthing location 34. Smaller polygons may highlight areas with greater wind impact and thus lower berthing feasibility, whereas larger polygons may indicate areas with lesser wind impact and higher berthing feasibility. Of course, the opposite order may also be envisaged (e.g. smaller polygons for higher berthing feasibility). The way the graphical indications are shown may be manually controllable by the operator.

In some examples, the berthing feasibility for the marine vessel 1 may be communicated to an external vessel system and/or a remote server. The external vessel system may be arranged on one or more second marine vessels 2. This may be done by the processing circuitry 102 via control of a communication device 24. This implies the existence of another vessel 2 with a communication device configurable to receive the berthing feasibility. The transmission may include sending the berthing map 30. These examples enable the sharing of berthing information with other vessels and/or centralized data repositories. By transmitting the berthing feasibility data, the external vessel systems and/or remote servers can obtain updates, potentially in real-time, on the suitability of various berthing locations. This communication can facilitate coordinated berthing operations, enhance navigational safety, and provide valuable data for fleet management and maritime authorities.

In addition to the berthing feasibility, vessel properties of the marine vessel 1 can also be sent to the external vessel system and/or the remote server. This additional information allows the receiving systems to better interpret the berthing feasibility data in the context of the reporting vessel's unique properties. By communicating both the berthing feasibility and vessel properties, a community-based approach to berthing feasibility determination can be obtained. For example, the second marine vessel 2 can obtain the berthing feasibility data and, optionally, the vessel properties of the first marine vessel 1 that determined the feasibility. This allows the second vessel 2 to adjust the received berthing feasibility data based on its own vessel properties, such as different hull depths or other characteristics.

Consider a scenario where the first marine vessel 1 determines that a specific berthing location has high feasibility based on its own hull depth and other properties. This information, along with the first vessel's 1 properties, is communicated to a remote server and/or other vessel systems in the vicinity, including a vessel system of the second marine vessel 2. The second vessel 2, which might have a deeper hull or different operational requirements, can use the received data to adjust the berthing feasibility assessment. By considering its own properties, the second vessel 2 can accurately determine whether the initially assessed feasible location is suitable for its own berthing needs. To this end, a re-assessment of the entire procedure discussed herein need not necessarily be performed, which can save processing power and provide a more consistent determination of berthing feasibility. This community-based sharing of berthing feasibility data and vessel properties may enhance the collective navigational safety and efficiency of multiple vessels operating in the same area 33. It can thus allow each vessel to make informed decisions based on comprehensive and contextually relevant data, fostering better coordination and reducing the risk of berthing-related incidents.

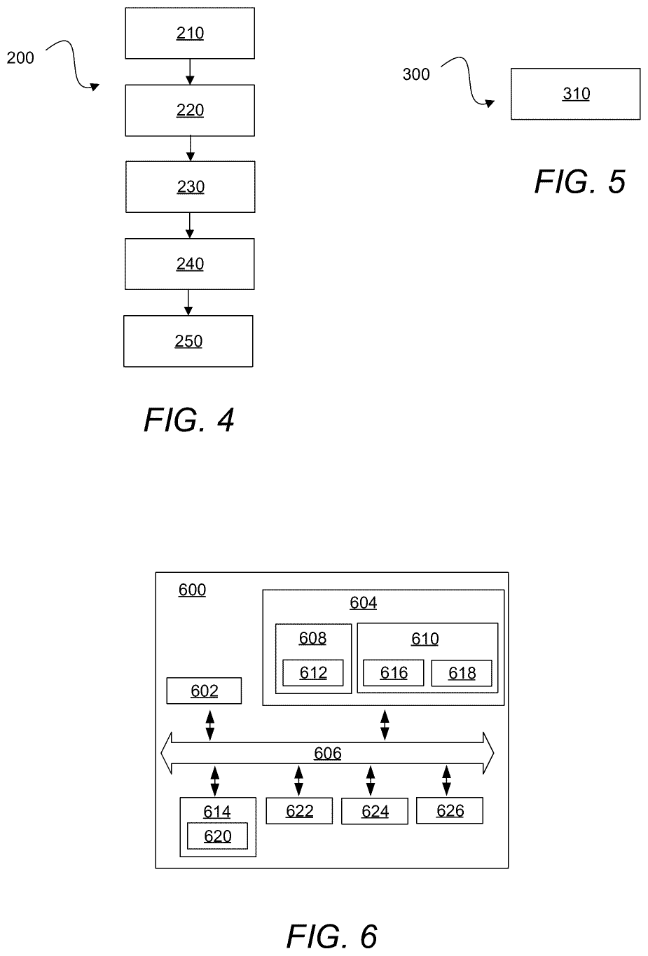

FIG. 4 is a flowchart of a computer-implemented method 200 for determining a berthing feasibility for a marine vessel. The method 200 is carried out by processing circuitry of a computer system. The method 200 comprises obtaining 210 localization data of one or more berthing areas in connection with one or more nature landmasses. The method 200 comprises, based on the localization data, identifying 220 at least one potential berthing location where the marine vessel can attempt to berth within the berthing areas. The method 200 comprises obtaining 230 wind forecast data for an upcoming berthing time period expected for the marine vessel at said at least one potential berthing location. The method 200 comprises, based on the wind forecast data, determining 240 a wind influence value for the marine vessel during said estimated upcoming berthing time period at said at least one potential berthing location, wherein a relatively higher wind influence value indicates a lesser berthing feasibility and a relatively lower wind influence indicates a greater berthing feasibility. The method 200 comprises determining 250 the berthing feasibility for the marine vessel at said at least one potential berthing location based on its respective wind influence value.

FIG. 5 is a flowchart of a computer-implemented method 300 comprising obtaining 310 a berthing feasibility for a second marine vessel based on a berthing feasibility determined for a first marine vessel according to the method 200 described above with reference to FIG. 4.

FIG. 6 is a schematic diagram of a computer system 600 for implementing examples disclosed herein. The computer system 600 is adapted to execute instructions from a computer-readable medium to perform these and/or any of the functions or processing described herein. The computer system 600 may be connected (e.g., networked) to other machines in a LAN (Local Area Network), LIN (Local Interconnect Network), automotive network communication protocol (e.g., FlexRay), an intranet, an extranet, or the Internet. While only a single device is illustrated, the computer system 600 may include any collection of devices that individually or jointly execute a set (or multiple sets) of instructions to perform any one or more of the methodologies discussed herein. Accordingly, any reference in the disclosure and/or claims to a computer system, computing system, computer device, computing device, control system, control unit, electronic control unit (ECU), processor device, processing circuitry, etc., includes reference to one or more such devices to individually or jointly execute a set (or multiple sets) of instructions to perform any one or more of the methodologies discussed herein. For example, control system may include a single control unit or a plurality of control units connected or otherwise communicatively coupled to each other, such that any performed function may be distributed between the control units as desired. Further, such devices may communicate with each other or other devices by various system architectures, such as directly or via a Controller Area Network (CAN) bus, etc.

The computer system 600 may comprise at least one computing device or electronic device capable of including firmware, hardware, and/or executing software instructions to implement the functionality described herein. The computer system 600 may include processing circuitry 602 (e.g., processing circuitry including one or more processor devices or control units), a memory 604, and a system bus 606. The computer system 600 may include at least one computing device having the processing circuitry 602. The system bus 606 provides an interface for system components including, but not limited to, the memory 604 and the processing circuitry 602. The processing circuitry 602 may include any number of hardware components for conducting data or signal processing or for executing computer code stored in memory 604. The processing circuitry 602 may, for example, include a general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The processing circuitry 602 may further include computer executable code that controls operation of the programmable device.

The system bus 606 may be any of several types of bus structures that may further interconnect to a memory bus (with or without a memory controller), a peripheral bus, and/or a local bus using any of a variety of bus architectures. The memory 604 may be one or more devices for storing data and/or computer code for completing or facilitating methods described herein. The memory 604 may include database components, object code components, script components, or other types of information structure for supporting the various activities herein. Any distributed or local memory device may be utilized with the systems and methods of this description. The memory 604 may be communicably connected to the processing circuitry 602 (e.g., via a circuit or any other wired, wireless, or network connection) and may include computer code for executing one or more processes described herein. The memory 604 may include non-volatile memory 608 (e.g., read-only memory (ROM), erasable programmable read-only memory (EPROM), electrically erasable programmable read-only memory (EEPROM), etc.), and volatile memory 610 (e.g., random-access memory (RAM)), or any other medium which can be used to carry or store desired program code in the form of machine-executable instructions or data structures and which can be accessed by a computer or other machine with processing circuitry 602. A basic input/output system (BIOS) 612 may be stored in the non-volatile memory 608 and can include the basic routines that help to transfer information between elements within the computer system 600.

The computer system 600 may further include or be coupled to a non-transitory computer-readable storage medium such as the storage device 614, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 614 and other drives associated with computer-readable media and computer-usable media may provide non-volatile storage of data, data structures, computer-executable instructions, and the like.

Computer-code which is hard or soft coded may be provided in the form of one or more modules. The module(s) can be implemented as software and/or hard-coded in circuitry to implement the functionality described herein in whole or in part. The modules may be stored in the storage device 614 and/or in the volatile memory 610, which may include an operating system 616 and/or one or more program modules 618. All or a portion of the examples disclosed herein may be implemented as a computer program 620 stored on a transitory or non-transitory computer-usable or computer-readable storage medium (e.g., single medium or multiple media), such as the storage device 614, which includes complex programming instructions (e.g., complex computer-readable program code) to cause the processing circuitry 602 to carry out actions described herein. Thus, the computer-readable program code of the computer program 620 can comprise software instructions for implementing the functionality of the examples described herein when executed by the processing circuitry 602. In some examples, the storage device 614 may be a computer program product (e.g., readable storage medium) storing the computer program 620 thereon, where at least a portion of a computer program 620 may be loadable (e.g., into a processor) for implementing the functionality of the examples described herein when executed by the processing circuitry 602. The processing circuitry 602 may serve as a controller or control system for the computer system 600 that is to implement the functionality described herein.

The computer system 600 may include an input device interface 622 configured to receive input and selections to be communicated to the computer system 600 when executing instructions, such as from a keyboard, mouse, touch-sensitive surface, etc. Such input devices may be connected to the processing circuitry 602 through the input device interface 622 coupled to the system bus 606 but can be connected through other interfaces, such as a parallel port, an Institute of Electrical and Electronic Engineers (IEEE) 1394 serial port, a Universal Serial Bus (USB) port, an IR interface, and the like. The computer system 600 may include an output device interface 624 configured to forward output, such as to a display, a video display unit (e.g., a liquid crystal display (LCD) or a cathode ray tube (CRT)). The computer system 600 may include a communications interface 626 suitable for communicating with a network as appropriate or desired.

The operational actions described in any of the exemplary aspects herein are described to provide examples and discussion. The actions may be performed by hardware components, may be embodied in machine-executable instructions to cause a processor to perform the actions, or may be performed by a combination of hardware and software. Although a specific order of method actions may be shown or described, the order of the actions may differ. In addition, two or more actions may be performed concurrently or with partial concurrence.

In further examples of the disclosure the following is provided.
Example 1: A computer system (100; 600) for determining a berthing feasibility for a marine vessel (1), the computer system (100; 600) comprising processing circuitry (102; 602) configured to: obtain localization data of one or more berthing areas (33) in connection with one or more nature landmasses (32); based on the localization data, identify at least one potential berthing location (34) where the marine vessel (1) can attempt to berth within the berthing areas (33); obtain wind forecast data for an upcoming berthing time period expected for the marine vessel (1) at said at least one potential berthing location (34); based on the wind forecast data, determine a wind influence value for the marine vessel (1) during said estimated upcoming berthing time period at said at least one potential berthing location (34), wherein a relatively higher wind influence value indicates a lesser berthing feasibility and a relatively lower wind influence indicates a greater berthing feasibility; and determine the berthing feasibility for the marine vessel (1) based on its respective wind influence value at said at least one potential berthing location (34).
Example 2: The computer system (100; 600) of example 1, wherein the processing circuitry (102; 602) is configured to determine the wind influence value by: obtaining the wind forecast data as a plurality of wind vectors, each wind vector comprising a direction and a magnitude of wind influence on the marine vessel (1) for a predetermined time sequence during the estimated upcoming berthing time period; and analyzing the stored wind vectors.
Example 3: The computer system (100; 600) of example 2, wherein the processing circuitry (102; 602) is configured to analyze the stored wind vectors by: increasing the wind influence value where the direction of the wind influence points towards the nature landmasses (32); and decreasing the wind influence value where the direction of the wind influence points away from the nature landmasses (32).
Example 4: The computer system (100; 600) of any of examples 2-3, wherein the processing circuitry (102; 602) is configured to analyze the stored wind vectors by: increasing the wind influence value where the magnitude of the wind influence is greater than a first wind tolerance value; and decreasing the wind influence value where the magnitude of the wind influence is lesser than the first wind tolerance value.
Example 5: The computer system (100; 600) of any of examples 2-4, wherein the processing circuitry (102; 602) is configured to analyze the stored wind vectors by: comparing magnitudes of the wind influence for the marine vessel (1) with respect to different potential berthing locations (34), and performing a relative weighing of the wind influence value among said different potential berthing locations (34) based on said comparison.
Example 6: The computer system (100; 600) of any of examples 2-5, wherein the processing circuitry (102; 602) is configured to analyze the stored wind vectors by: omitting potential berthing locations (34) where the direction of the wind influence points towards the nature landmasses (32) and the magnitude of the wind influence is greater than a second wind tolerance value.
Example 7: The computer system (100; 600) of any of examples 1-6, wherein the processing circuitry (102; 602) is further configured to: obtain seabed topography data for each potential berthing location (34); and determine the berthing feasibility for the marine vessel (1) based on the seabed topography data and vessel properties of the marine vessel (1).
Example 8: The computer system (100; 600) of any of examples 1-7, wherein the processing circuitry (102; 602) is further configured to: obtain landmass topography data for the one or more nature landmasses (32); and determine the berthing feasibility for the marine vessel (1) based on the landmass topography data.
Example 9: The computer system (100; 600) of any of examples 1-8, wherein the processing circuitry (102; 602) is further configured to generate a berthing map (30) being a virtual representation of said one or more berthing areas (33) and said one or more nature landmasses (32), the berthing map (30) involving one or more graphical indications of the berthing feasibility for the marine vessel (1).
Example 10: The computer system (100; 600) of example 9, wherein the processing circuitry (102; 602) is configured to highlight the graphical indications of the berthing map (30) according to an order of the berthing feasibility.
Example 11: The computer system (100; 600) of example 10, wherein the graphical indications comprise a polygon having a size determined based on the order of the berthing feasibility, wherein the higher the wind influence value the greater the size of the polygon.
Example 12: The computer system of any of examples 1-11, wherein the processing circuitry (102; 602) is configured to identify said at least one potential berthing location (34) in response to a user request or an automatic system trigger.
Example 13: The computer system (100; 600) of example 12, wherein the automatic system trigger is based on historical berthing data.
Example 14: The computer system (100; 600) of any of examples 1-13, wherein the at least one potential berthing location (34) within the berthing areas (33) where the marine vessel (1) can attempt to berth comprises one of a location in direct mooring contact with the one or more nature landmasses (32), or a location at a distance from the one or more nature landmasses (32).
Example 15: The computer system (100; 600) of any of examples 1-14, wherein the processing circuitry (102; 602) is further configured to communicate the berthing feasibility for the marine vessel (1) to one or more of an external vessel system and a remote server.
Example 16: The computer system (100; 600) of example 15, wherein the processing circuitry (102; 602) is further configured to communicate vessel properties of the marine vessel (1) in conjunction with the berthing feasibility to said one or more of an external vessel system and a remote server.
Example 17: The computer system (100; 600) of any of examples 1-16, wherein the processing circuitry (102; 602) is configured to obtain the localization data from one or more of a distance sensor (10) and a sea chart service (12).
Example 18: The computer system (100; 600) of any of examples 1-17, wherein the processing circuitry (102; 602) is configured to obtain the weather forecast data from a weather forecast service (14) in the format of one or more of General Regularly-Distributed Information (GRIB) in Binary form and World Meteorological Organization (WMO) standard format for achieving and exchanging gridded data.
Example 19: The computer system (100; 600) of any of examples 1-18, wherein the processing circuitry (102; 602) is configured to control an alarm system to activate an alarm in response to identifying a change in the wind forecast data exceeding a limit value.
Example 20: A marine vessel (1) comprising the computer system (100; 600) of any of examples 1-19.
Example 21: A computer-implemented method (200) for determining a berthing feasibility for a marine vessel (1), comprising: obtaining (210), by processing circuitry (102; 602) of a computer system (100; 600), localization data of one or more berthing areas (33) in connection with one or more nature landmasses (32); based on the localization data, identifying (220), by the processing circuitry (102; 602), at least one potential berthing location (34) where the marine vessel (1) can attempt to berth within the berthing areas (33); obtaining (230), by the processing circuitry (102; 602), wind forecast data for an upcoming berthing time period expected for the marine vessel (1) at said at least one potential berthing location (34); based on the wind forecast data, determining (240), by the processing circuitry (102; 602), a wind influence value for the marine vessel (1) during said estimated upcoming berthing time period at said at least one potential berthing location (34), wherein a relatively higher wind influence value indicates a lesser berthing feasibility and a relatively lower wind influence indicates a greater berthing feasibility; and determining (250), by the processing circuitry (102; 602), the berthing feasibility for the marine vessel (1) at said at least one potential berthing location (34) based on its respective wind influence value.
Example 22: A computer-implemented method (300) comprising obtaining (310) a berthing feasibility for a second marine vessel (2) based on a berthing feasibility determined for a first marine vessel (1) according to the method (200) of example 21.
Example 23: The method (300) of example 22, further comprising obtaining (320) vessel properties of the first marine vessel (1), and adapting the obtained berthing feasibility based on vessel properties of the second marine vessel (2).
Example 24: A computer program product comprising program code for performing, when executed by the processing circuitry (102; 602), the method (200) of example 21.
Example 25: A non-transitory computer-readable storage medium comprising instructions, which when executed by the processing circuitry (102; 602), cause the processing circuitry (102; 602) to perform the method (200) of example 21.
Example 26: A computer program product comprising program code for performing, when executed by the processing circuitry (102; 602), the method (300) of example 22.
Example 27: A non-transitory computer-readable storage medium comprising instructions, which when executed by the processing circuitry (102; 602), cause the processing circuitry (102; 602) to perform the method (300) of example 22.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

What is claimed is:

1. A computer system for determining a berthing feasibility for a marine vessel, the computer system comprising processing circuitry configured to:
obtain localization data of one or more berthing areas in connection with one or more nature landmasses;
based on the localization data, identify at least one potential berthing location where the marine vessel can attempt to berth within the berthing areas;
obtain wind forecast data for an upcoming berthing time period expected for the marine vessel at said at least one potential berthing location, wherein the wind forecast data is obtained as a plurality of wind vectors, each wind vector comprising a direction and a magnitude of wind influence on the marine vessel for a predetermined time sequence during the estimated upcoming berthing time period;
based on the wind forecast data, determine a wind influence value for the marine vessel during said estimated upcoming berthing time period at said at least one potential berthing location by analyzing the stored wind vectors, wherein a relatively higher wind influence value indicates a lesser berthing feasibility and a relatively lower wind influence indicates a greater berthing feasibility; and
determine the berthing feasibility for the marine vessel based on its respective wind influence value at said at least one potential berthing location.

2. The computer system of claim 1, wherein the processing circuitry is configured to analyze the stored wind vectors by:
increasing the wind influence value where the direction of the wind influence points towards the nature landmasses; and
decreasing the wind influence value where the direction of the wind influence points away from the nature landmasses.

3. The computer system of claim 1, wherein the processing circuitry is configured to analyze the stored wind vectors by:
increasing the wind influence value where the magnitude of the wind influence is greater than a first wind tolerance value; and
decreasing the wind influence value where the magnitude of the wind influence is lesser than the first wind tolerance value.

4. The computer system of claim 1, wherein the processing circuitry is configured to analyze the stored wind vectors by:
comparing magnitudes of the wind influence for the marine vessel with respect to different potential berthing locations, and performing a relative weighing of the wind influence value among said different potential berthing locations based on said comparison.

5. The computer system of claim 1, wherein the processing circuitry is configured to analyze the stored wind vectors by:
omitting potential berthing locations where the direction of the wind influence points towards the nature landmasses and the magnitude of the wind influence is greater than a second wind tolerance value.

6. The computer system of claim 1, wherein the processing circuitry is further configured to:
obtain seabed topography data for each potential berthing location; and
determine the berthing feasibility for the marine vessel based on the seabed topography data and vessel properties of the marine vessel.

7. The computer system of claim 1, wherein the processing circuitry is further configured to:
obtain landmass topography data for the one or more nature landmasses; and
determine the berthing feasibility for the marine vessel based on the landmass topography data.

8. The computer system of claim 1, wherein the processing circuitry is further configured to generate a berthing map being a virtual representation of said one or more berthing areas and said one or more nature landmasses, the berthing map involving one or more graphical indications of the berthing feasibility for the marine vessel.

9. The computer system of claim 8, wherein the graphical indications of the berthing map are highlighted according to an order of the berthing feasibility.

10. The computer system of claim 9, wherein the graphical indications comprise a polygon having a size determined based on the order of the berthing feasibility, wherein the higher the wind influence value the greater the size of the polygon.

11. The computer system of claim 1, wherein the processing circuitry is configured to identify said at least one potential berthing location in response to a user request or an automatic system trigger.

12. The computer system of claim 11, wherein the automatic system trigger is based on historical berthing data.

13. The computer system of claim 1, wherein the at least one potential berthing location within the berthing areas where the marine vessel can attempt to berth comprises one of a location in direct mooring contact with the one or more nature landmasses, or a location at a distance from the one or more nature landmasses.

14. The computer system of claim 1, wherein the processing circuitry is further configured to communicate the berthing feasibility, and optionally vessel properties, of the marine vessel to one or more of an external vessel system and a remote server.

15. The computer system of claim 14, wherein the processing circuitry is further configured to communicate vessel properties of the marine vessel in conjunction with the berthing feasibility to said one or more of an external vessel system and a remote server.

16. A marine vessel comprising the computer system of claim 1.

17. A computer-implemented method for determining a berthing feasibility for a marine vessel, comprising:
obtaining, by processing circuitry of a computer system, localization data of one or more berthing areas in connection with one or more nature landmasses;
based on the localization data, identifying, by the processing circuitry, at least one potential berthing location where the marine vessel can attempt to berth within the berthing areas;
obtaining, by the processing circuitry, wind forecast data for an upcoming berthing time period expected for the marine vessel at said at least one potential berthing location;
based on the wind forecast data, determining, by the processing circuitry, a wind influence value for the marine vessel during said estimated upcoming berthing time period at said at least one potential berthing location, wherein a relatively higher wind influence value indicates a lesser berthing feasibility and a relatively lower wind influence indicates a greater berthing feasibility; and
determining, by the processing circuitry, the berthing feasibility for the marine vessel at said at least one potential berthing location based on its respective wind influence value.

18. A computer-implemented method comprising:
obtaining a berthing feasibility for a second marine vessel based on a berthing feasibility determined for a first marine vessel according to the method of claim 17, and
optionally, obtaining vessel properties of the first marine vessel and adapting the obtained berthing feasibility based on vessel properties of the second marine vessel.

19. A computer program product comprising program code for performing, when executed by the processing circuitry, the method of claim 17.

20. A non-transitory computer-readable storage medium comprising instructions, which when executed by the processing circuitry, cause the processing circuitry to perform the method of claim 17.
